(19) United States
(12) Patent Application Publication
(10) Pub. No.: US 2018/0293035 A1
(43) Pub. Date: Oct. 11, 2018

(54) NON-TRANSITORY COMPUTER READABLE MEDIUM, PRINT CONTROL DEVICE, AND PRINT CONTROL SYSTEM

(71) Applicant: FUJITSU LIMITED, Kawasaki-shi (JP)

(72) Inventors: Junki Hakamata, Yokohama (JP); Osamu Kasuga, Shizuoka (JP); Tetsuhiro Yamaguchi, Yokohama (JP)

(73) Assignee: FUJITSU LIMITED, Kawasaki-shi (JP)

(21) Appl. No.: 15/942,697

(22) Filed: Apr. 2, 2018

(30) Foreign Application Priority Data
Apr. 5, 2017 (JP) 2017-075440

(51) Int. Cl. G06F 3/12

(52) U.S. Cl. CPC G06F 3/1255; G06F 3/1288; G06F 3/1256; G06F 3/1204

(57) ABSTRACT

A non-transitory computer readable medium storing a program that causes a computer to execute a process, the computer transmitting a print instruction data to a server device, the process including obtaining information regarding a printer device from the server device, the server device transmitting print output data, the printer device to which the print output data is transmitted being determined based on an output request from the printer device or output destination information included in the print instruction data received from the computer, determining whether the server is available upon a reception of a print operation, presenting candidates of the printer device to which the print output data corresponding to the print operation is transmitted based on the information when the server is determined to be not available, and transmitting the print output data corresponding to the print operation to a specific printer device selected from the candidates.

### CROSS-REFERENCE TO RELATED APPLICATION

This application is based upon and claims the benefit of priority of the prior Japanese Patent Application No. 2017-75440, filed on Apr. 5, 2017, the entire contents of which are incorporated herein by reference.

### FIELD

The embodiments discussed herein are related to a non-transitory computer readable medium, a print control device, and a print control system.

### BACKGROUND

A print system has been used in which, by using a server which two or more printing machines are allowed to access, print instruction data is transmitted from a terminal to the server, print data is transmitted from the server to a printing machine that is to perform print output in response to data selection through the printing machine, and the print output through the printing machine is performed. In the above-described print system, printing may be performed without specifying a printing machine that is to perform the print output in advance.

Japanese Laid-open Patent Publication No. 2012-194744, Japanese Laid-open Patent Publication No. 2010-271988, Japanese Laid-open Patent Publication No. 2015-053072 are examples of the related art.

### SUMMARY

According to an aspect of the invention, a non-transitory computer readable medium storing a program that causes a computer to execute a process, the computer transmitting a print instruction data to a server device, the process including obtaining information regarding a printer device from the server device, the server device transmitting print output data to execute a printing to the printer device, the printer device to which the print output data is transmitted being determined based on an output request from the printer device or output destination information included in the print instruction data received from the computer, determining whether the server is available upon a reception of a print operation, presenting candidates of the printer device to which the print output data corresponding to the print operation is transmitted based on the information when the server is determined to be not available, and transmitting the print output data corresponding to the print operation to a specific printer device selected from the candidates.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an overall configuration of a print management system according to embodiments;

FIG. 2 is a diagram illustrating an example of a terminal according to a first embodiment;

FIG. 3 is a diagram illustrating an example of a server;

FIG. 4 is a diagram illustrating an example of a printing machine;

FIG. 5 is a diagram illustrating an example of management information on output destination printing machines;

FIG. 6 is a diagram illustrating an example of setting information on regular printing machines;

FIG. 7 is a diagram illustrating an example of print output logs;

FIG. 8 is a diagram illustrating an example of information indicating output destination printing machine candidates stored in the terminal;

FIG. 9 is a diagram illustrating an example of a selection screen for the output destination printing machine candidates in the terminal;

FIG. 10 is a diagram illustrating an example of a job list screen of the printing machine;

FIG. 11 is a flowchart illustrating an example of processing of the terminal according to the first embodiment;

FIG. 12 is a flowchart illustrating an example of processing of the server according to the first embodiment;

FIG. 13 is a flowchart illustrating an example of processing of the printing machine according to the first embodiment;

FIG. 14 is a diagram illustrating an example of processing of the terminal when the server according to the first embodiment is not available;

FIG. 15 is a flowchart illustrating a modification of the processing of the server according to the first embodiment;

FIG. 16 is a flowchart illustrating a modification of the processing of the printing machine according to the first embodiment;

FIG. 17 is a diagram illustrating an example of a terminal according to a second embodiment;

FIG. 18 is a flowchart illustrating an example of processing of the terminal when a server according to the second embodiment is not available;

FIG. 19 is a diagram illustrating an example of a terminal according to a third embodiment;

FIG. 20 is a flowchart illustrating an example of processing of the terminal according to the third embodiment;

FIG. 21 is a flowchart illustrating an example of processing of a server according to the third embodiment;

FIG. 22 is a flowchart illustrating an example of processing of the terminal when the server according to the third embodiment is not available;

FIG. 23 is a diagram illustrating an example of a hardware configuration of the terminal;

FIG. 24 is a diagram illustrating an example of a hardware configuration of the server; and

FIG. 25 is a diagram illustrating an example of a hardware configuration of the printing machine.

### DESCRIPTION OF EMBODIMENTS

In the system in which printing is performed by using the server as described above, when the server is not available due to, for example, the occurrence of a failure in the server, or the like, it is difficult to instruct execution of printing from the terminal unless information on the printing machine that is to perform print output is set up separately.

An aspect of an embodiment of the technology discussed herein is to increase the convenience of printing in a state in which a server used to execute printing is not available.

### Example of Overall Configuration of a System According to Embodiments

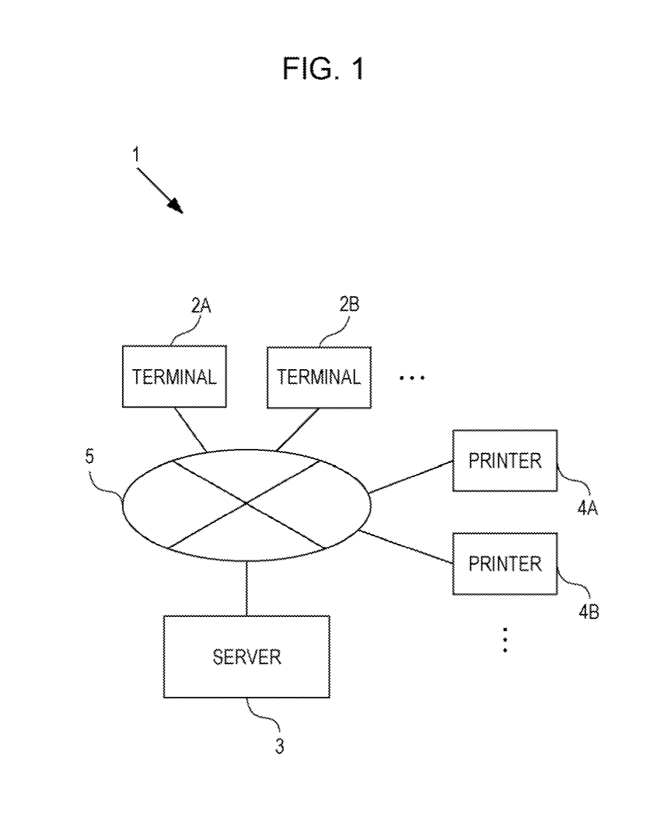

FIG. 1 is a diagram illustrating an example of a print management system according to embodiments. In a print management system 1, two or more terminals 2 (2A, 2B, . . . ), a server 3, two or more printing machines 4 (4A, 4B, . . . ) are coupled to each other through a network 5. Only a single terminal 2 may be coupled to the network 5.

When the terminal 2 accepts a print instruction operation from a user, the terminal 2 generates intermediate format data used to instruct the printing machine 4 to execute specific printing. In addition, the terminal 2 transmits print job data including attribute information and the intermediate format data to the server 3. The terminal 2 is an example of a computer. In addition, the terminal 2 is an example of a print management device. In addition, the print job data is an example of print instruction data.

The attribute information includes one or both of identification information on a user who has performed the print instruction operation and identification information on the terminal 2. The identification information on the user is, for example, a user identification (ID). The identification information on the terminal 2 is, for example, a terminal ID.

The intermediate format data may be, for example, extensible markup language (XML) paper specification (XPS) based on XML. The intermediate format data is print data having high versatility, which is allowed to be interpreted by two or more types of the printing machines 4.

The terminal 2 is a specific computer. For example, the terminal 2 may be a personal computer, a tablet terminal, a smartphone, or the like. In addition, the terminal 2 may be a thin client terminal having a small amount of hardware resources.

The server 3 manages the two or more printing machines 4 coupled to the network 5. The server 3 receives the print job data that has been transmitted from the terminal 2 and transmits the intermediate format data to a printing machine 4 that is a print output destination. The server 3 may convert the intermediate format data into print format data and transmit the print format data to the printing machine 4 that is the print output destination.

The print format data is print data corresponding to the printing machine 4 that is the print output destination (hereinafter may be referred to as an output destination). That is, the print format data is data having a format with which the printing machine 4 that is the output destination is allowed to execute printing without format conversion. The print format data may be, for example, a page description language (PDL).

The printing machine 4 may be a printing machine dedicated to a print function or a multi-function printing machine or the like having a function achieved by adding a facsimile function, a copy function, and the like to the print function. Hereinafter, the printing machine may be referred to a printer.

In the embodiment, it is assumed that two or more types of the printing machines 4 are coupled to the network 5. For example, it is assumed that the two or more printing machines 4 having different venders (supply sources) or different models are coupled to the network 5.

The network 5 according to the embodiment is, for example, an internet-based network. The network 5 may be an internal network such as a local area network (LAN).

### Example of a Terminal Corresponding to a First Embodiment

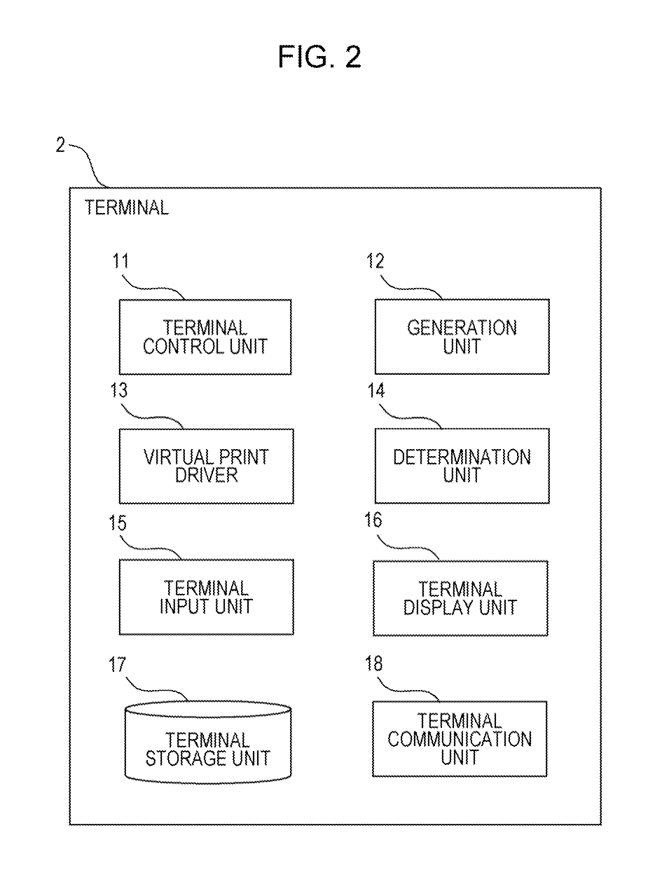

FIG. 2 is a diagram illustrating an example of a terminal according to a first embodiment. A terminal 2 according to the first embodiment includes a terminal control unit 11, a generation unit 12, a virtual print driver 13, a determination unit 14, a terminal input unit 15, a terminal display unit 16, a terminal storage unit 17, and a terminal communication unit 18.

The terminal control unit 11 performs various kinds of control of the terminal 2. The generation unit 12 generates print data in response to a print instruction operation from the user. For example, the print data is document data, image data, or the like generated by a specific application program (hereinafter referred to as software) executed by the terminal 2. The print instruction operation is, for example, an operation related to a print instruction, which is executed by the software.

The virtual print driver 13 generates intermediate format data corresponding to the two or more printing machines 4 from the print data that has been generated by the generation unit 12. For example, the virtual print driver 13 is used by a print function of the above-described software.

The determination unit 14 determines whether the server 3 is available, in response to reception of the print instruction operation performed by the user. For example, when the terminal 2 has accepted the print instruction operation performed by the user, the determination unit 14 determines an operation status of the server 3, and determines whether the server 3 is available in accordance with the operation status.

When the determination unit 14 has determined that the server 3 is not available, the terminal control unit 11 presents candidates for an output destination printing machine on the terminal display unit 16 in accordance with information on candidates for an output destination printing machine, which is stored in the terminal storage unit 17.

The terminal input unit 15 is an input unit used to accept specific input to the terminal 2. For example, the terminal input unit 15 may include a keyboard and a mouse. When a selection operation has been performed for one of the presented candidates of the output destination printing machine, the terminal input unit 15 accepts the selection operation. The terminal display unit 16 is a display unit that displays specific information. For example, the terminal display unit 16 may be a display or the like. The terminal input unit 15 and the terminal display unit 16 are integrated as a touch panel display or the like.

The terminal storage unit 17 stores the information on candidates for a printing machine 4 that is an output destination, which has been transmitted from the server 3. In the following description, the candidate for the printing machine 4 that is the output destination may be referred to as an output destination printing machine candidate.

The terminal communication unit 18 communicates with the server 3 through the network 5. The terminal communication unit 18 transmits print job data including attribute information and intermediate format data to the server 3. The print job data may include, for example, various kinds of information (meta information) related to printing such as a print time.

The terminal communication unit 18 obtains the information indicating output destination printing machine candidates from the server 3. The terminal control unit 11 stores the information in the terminal storage unit 17. In addition, the terminal communication unit 18 transmits the intermediate format data that has been generated by the virtual print driver 13 to the printing machine 4 that has been selected by the user.

### Example of the Server According to the First Embodiment

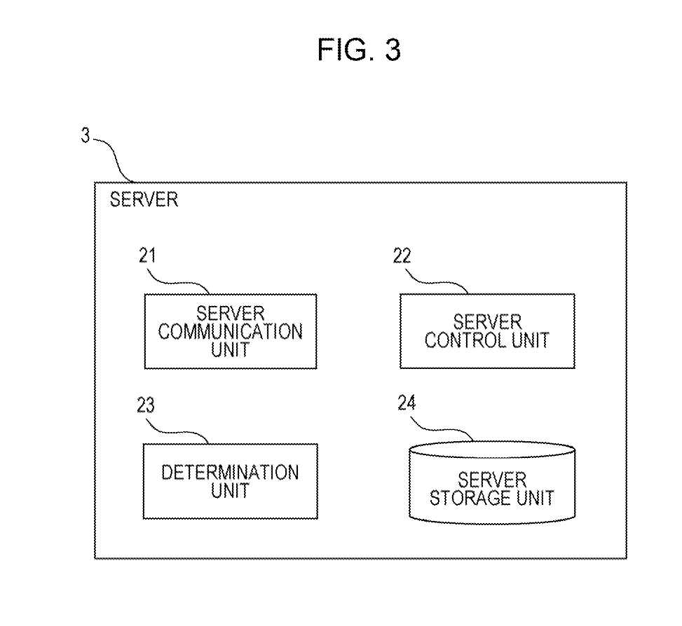

FIG. 3 is a diagram illustrating an example of the server. The server 3 includes a server communication unit 21, a server control unit 22, a determination unit 23, and a server storage unit 24.

The server communication unit 21 receives the print job data from the terminal 2. In addition, the server communication unit 21 transmits the print job data that has been received from the terminal 2 to the printing machine 4 determined in accordance with output destination printing machine information included in print setting of the print job data or an output request from the printing machine 4. The print job data transmitted to the printing machine 4 is an example of print output data.

The server control unit 22 stores the print job data that has been received from the terminal 2 in the server storage unit 24.

The determination unit 23 determines an output destination printing machine candidate. The determination unit 23 determines a printing machine 4 that is the previous output destination of the terminal 2 or the user indicated by the attribute information, to be an output destination printing machine candidate, for example, with reference to print output logs. For example, the determination unit 23 may determine a regular printing machine of setting information stored in the server storage unit 24 to be an output destination printing machine candidate.

In addition, the server communication unit 21 transmits information indicating the determined output destination printing machine candidate to the terminal 2.

### Example of the Printing Machine

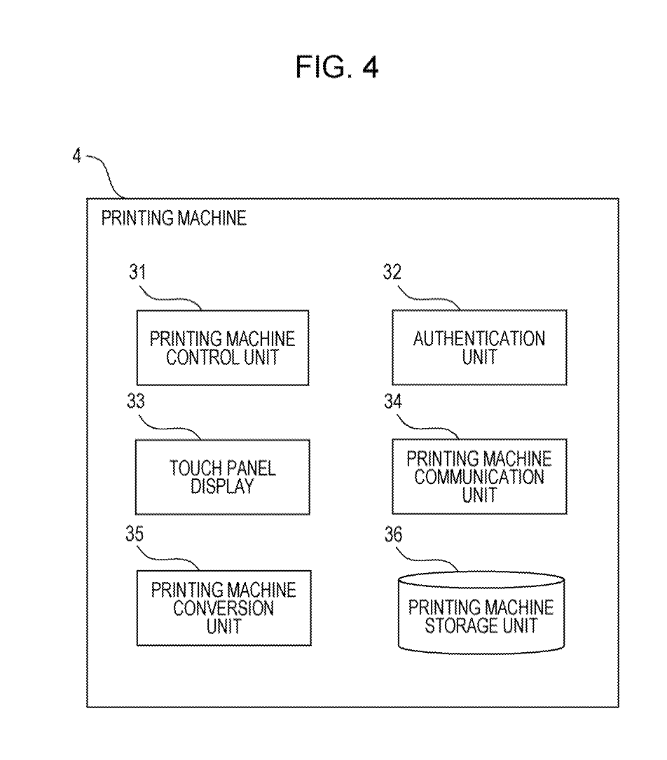

FIG. 4 is a diagram illustrating an example of the printing machine. The printing machine 4 includes a printing machine control unit 31, an authentication unit 32, a touch panel display 33, a printing machine communication unit 34, a printing machine conversion unit 35, and a printing machine storage unit 36.

The printing machine control unit 31 performs various kinds of control of the printing machine 4. For example, the printing machine control unit 31 controls a print mechanism built in the printing machine 4 to execute printing on a specific paper sheet (printing paper or the like). The printing machine control unit 31 controls the print mechanism to execute printing based on the print format data that has been received from the server 3.

The authentication unit 32 authenticates whether the user has the authority to operate the printing machine 4. For example, the authentication unit 32 recognizes user information used to identify the user who operates the printing machine 4. The user information includes, for example, a user ID.

For example, when a card reader is installed to the printing machine 4, the card reader performs short range wireless communication with a non-contact card of the user, the authentication unit 32 may recognize the user information. In addition, when the touch panel display 33 has accepted an input of the user information, the authentication unit 32 may authenticate a user in accordance with the accepted user information.

The touch panel display 33 includes a display function and an input function. The display function and the input function may be respectively realized by different devices. For example, the display function may be realized by a display and the input function may be realized by a push key or the like. For example, the touch panel display 33 displays a job list screen in accordance with the print job data that has been transmitted from the server 3.

The printing machine communication unit 34 communicates with the server 3 through the network 5. The printing machine communication unit 34 transmits, to the server 3, user information (for example, a user ID) used to identify the user who operates the printing machine 4 and information (for example, a printing machine name) used to identify the printing machine 4. In addition, the printing machine communication unit 34 transmits, to the server 3, information (for example, a job ID) used to identify the job that has been selected from the job list screen.

When the printing machine 4 has received intermediate format data from the server 3, the printing machine conversion unit 35 converts the intermediate format data into print format data. The printing machine conversion unit 35 may not perform the conversion when the printing machine 4 has received print format data from the server 3. The printing machine storage unit 36 stores specific information.

### Example of Information Stored in the Server Storage Unit

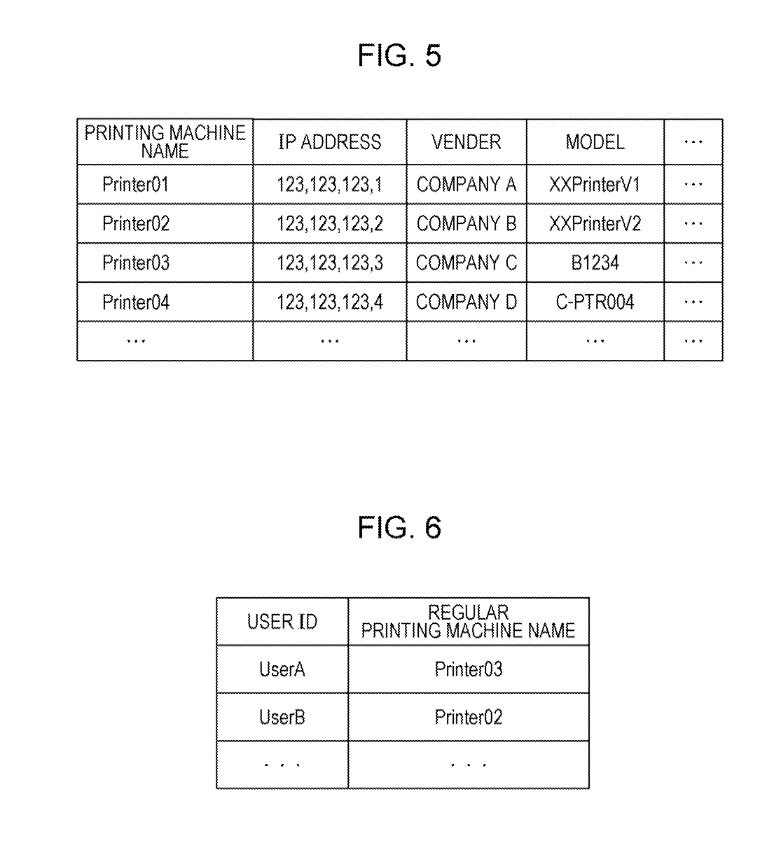

Pieces of information stored in the server storage unit 24 are described below. FIG. 5 is a diagram illustrating an example of management information on output destination printing machines. The management information on printing machines, which is stored in the server storage unit 24, is information on the printing machines 4, which is managed by the server 3. As illustrated in FIG. 5, the management information on the output destination printing machines, which is stored in the server storage unit 24, includes, for example, a printing machine name, an IP address of the printing machine, a vender, and a model (model name). The IP address is used, for example, to identify a printing machine 4. FIG. 6 is a diagram illustrating an example of setting information on regular printing machines. The regular printing machine may be used as an output destination printing machine candidate. As illustrated in FIG. 6, in the setting information, a user ID used to identify a user and a regular printing machine name are associated with each other.

In addition, in the example illustrated in FIG. 6, a single user ID is associated with a single regular printing machine, but may be associated with two or more regular printing machines. In addition, identification information (terminal ID) on a terminal 2 may be associated with a regular printing machine. A determination method of a regular printing machine in the setting information is described later.

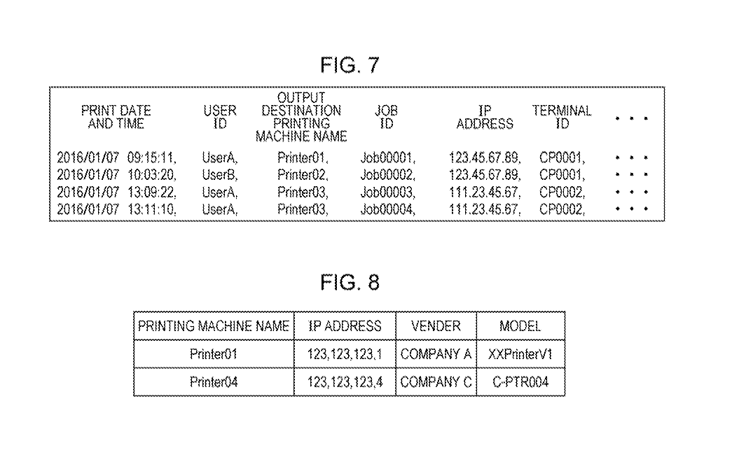

FIG. 7 is a diagram illustrating an example of print output logs. As illustrated in FIG. 7, the print output log includes a print date and time, a user ID, an output destination printing machine name, a job ID, an IP address of a terminal, and a terminal ID. The print output logs are used, for example, to determine a regular printing machine by the determination unit 23.

For example, the determination unit 23 determines, for each user, a printing machine 4 that has performed the most print output within a specific past time period to become a regular printing machine. This is why it is conceived that a printing machine 4 that has performed the most print output in the past is highly likely to be used by the user next time. The determination unit 23 may determine, for each user, a printing machine 4 that has performed print output a specific number of times or more within the specific past time period to become a regular printing machine.

The determination unit 23 may predict a printing machine 4 to be used by the user next time by using a statistical method, artificial intelligence (AI), or the like, for print output logs during the specific time period and set the predicted printing machine 4 as a regular printing machine in the setting information in accordance with the prediction result. In addition, the determination unit 23 may adjust a time period (specific time period) of print output logs, which is used to determine a regular printing machine. This is why a printing machine 4 having high frequency of usage is changed, for example, due to a change in the affiliation, a change in the work place, or the like.

In addition, the regular printing machine in the setting information may be a printing machine 4 that has been specified by the user in advance. For example, the determination unit 23 may determine a regular printing machine in accordance with print output logs when a regular printing machine has not been specified by the user in advance.

### Example of Information on the Terminal

FIG. 8 is a diagram illustrating an example of information indicating output destination printing machine candidates, which is stored in the terminal. The information indicating the output destination printing machine candidates illustrated in FIG. 8 is information transmitted from the server communication unit 21 and stored in the terminal storage unit 17.

As illustrated in FIG. 8, the information indicating the output destination printing machine candidates includes a printing machine name, an IP address, a vender, and a model (model name). The output destination printing machine candidates illustrated in FIG. 8 are stored, for example, for each user or each terminal.

### Example of a Screen Display

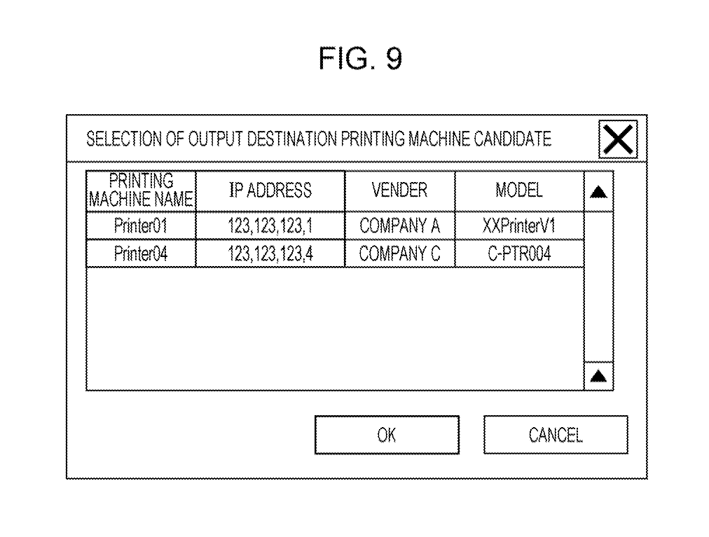

FIG. 9 is a diagram illustrating an example of a selection screen for the output destination printing machine candidates in the terminal 2. The screen illustrated in FIG. 9 is a screen displayed on the terminal display unit 16 of the terminal 2 when the server 3 is not available. As illustrated in FIG. 9, the selection screen for the output destination printing machine candidates includes a printing machine name, an IP address of the printer, a vender, and a model (model name).

For example, in a case in which the terminal display unit 16 is a touch panel display, when the user touches one of the output destination printing machine candidates, a printing machine 4 that is an output destination is selected.

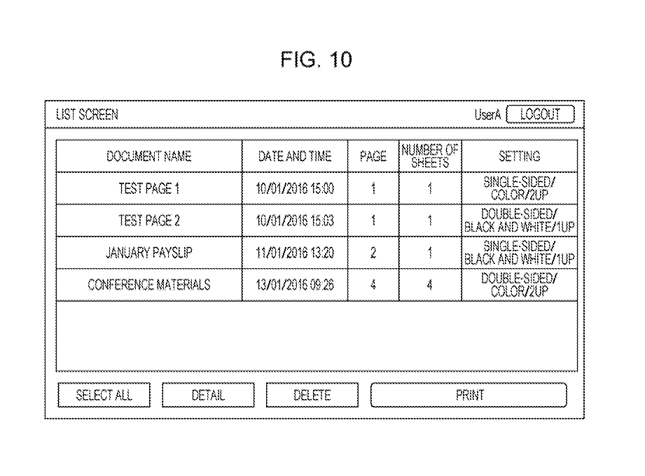

FIG. 10 is a diagram illustrating an example of a job list screen displayed on a touch panel display of the printing machine. Meta information on a print job of the user who has been authentication by the authentication unit 32 is transmitted from the server 3 to the printing machine 4. In addition, the touch panel display 33 displays the job list screen as illustrated in FIG. 10 in accordance with the transmitted meta information on print jobs.

The job list screen illustrated in FIG. 10 includes a user ID, a document name, a date and time (date and time at the time of a print instruction operation), a page (page number), the number of sheets, and setting (print setting). A display content of the job list screen is not limited to the content illustrated in FIG. 10.

For example, when the user touches one of the items of the job list screen of FIG. 10, a corresponding job is selected, and the printing machine communication unit 34 transmits the job ID of the selected job to the server 3.

### Example of Processing of the Terminal According to the First Embodiment

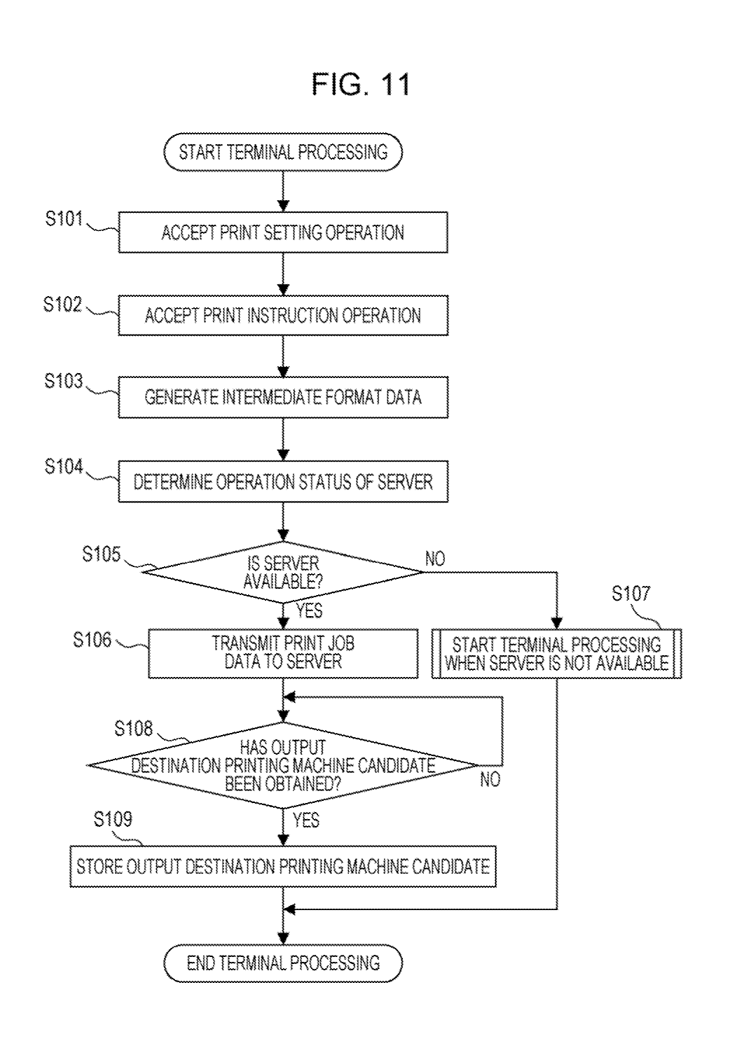

FIG. 11 is a flowchart illustrating an example of processing of the terminal according to the first embodiment. For example, it is assumed that the user who operates the terminal 2 has started specific software (for example, document creation software or the like), and an operation to open a corresponding file has been performed on the terminal input unit 15.

The terminal 2 accepts the operation, starts the specified software, and opens the corresponding file. In addition, it is assumed that a print setting operation of the software that is being executed has been performed on the terminal 2. The terminal 2 accepts the print setting operation (step S101). The print setting is, for example, setting of single-sided print or double-sided print, setting of color print or white/black print, setting of the presence or absence of consolidation such as allocation, or the like. The print setting may include information indicating a printing machine 4 that is an output destination.

When the print instruction operation is performed on the terminal 2, the terminal 2 accepts the print instruction operation (step S102). In addition, the generation unit 12 generates print data. The print data may include a single piece of data (for example, document data) or two or more pieces of data (for example, document data and image data).

A print execution target may be data stored in the terminal 2 such as a text file or a display content based on information that has been obtained from the outside of the terminal 2 such as a display screen of a browser.

The virtual print driver 13 generates intermediate format data based on the print data (step S103).

The determination unit 14 determines the operation status of the server 3 (step S104). In addition, the determination unit 14 determines whether the server 3 is available (step S105).

For example, when the determination unit 14 has accepted the print instruction operation, the determination unit 14 transmits a detection signal to the server 3 through the terminal communication unit 18 and determines the operation status of the server 3 depending on whether a response for the detection signal has been received.

When the determination unit 14 has received a response for the detection signal from the server 3, the determination unit 14 determines that the server 3 is available, and when the determination unit 14 has not received a response for the detection signal from the server 3, the determination unit 14 determines that the server 3 is not available. When the determination unit 14 has not received a response from the server 3, for example, it is assumed that it is difficult for the terminal 2 to communicate with the server 3 due to a failure in the network 3, to receive a response from the server 3 due to a failure in the server 3, or the like.

The determination unit 14 may execute processing in which the status of the server 3 is detected by a detection signal or the like at specific timing even when the terminal 2 has accepted the print instruction operation. For example, the determination unit 14 may detect the status of the server 3 by transmitting a detection signal to the server 3 at specific time interval. In addition, the determination unit 14 may perform the determination in accordance with the latest detection result when the terminal 2 has accepted the print instruction operation. The determination unit 14 may execute the processing of steps S104 and S105 early by using a result of the already-performed detection.

In addition, terminal control unit 12 may obtain information on the operation status by detecting the status of the server 3 regularly or at the specific timing. For example, the information may be information indicating the communication load for the server 3, the usage rate of a central processing unit (CPU) of the server 3, the usage rate of a memory, or the like. In addition, the information on the operation status of the server 3 may be information indicating whether the server 3 is under maintenance.

When the communication load for the server 3 is a specific value or more, the determination unit 14 may determine that the server 3 is not available. When the usage rate of the CPU or the memory is a specific value or more, the determination unit 14 may determine that the server 3 is not available. In addition, when the terminal 2 has received information indicating that the server 3 is under maintenance, the determination unit 14 may determine that the server 3 is not available.

When the determination unit 14 has determined that the server 3 is available (YES in step S105), the terminal communication unit 18 of the terminal 2 transmits, to the server 3, print job data including intermediate format data and attribute information (step S106). The attribute information includes one or both of identification information on the user who has performed the print instruction operation (for example, a user ID) and identification information on the terminal 2 (for example, a terminal ID). The intermediate format data includes the print setting that has been accepted in step S101.

When the determination unit 14 has determined that the server 3 is not available (NO in step S105), the terminal 2 executes processing when the server is not available (step S107). The processing when the server is not available is described in detail later.

After the processing of step S106, the terminal control unit 11 waits until the terminal control unit 11 receives (obtains) information indicating an output destination printing machine candidate from the server 3, and the flow does not proceed to the next processing before reception of the information (NO in step S108).

When the terminal control unit 11 has received the information indicating an output destination printing machine candidate (YES in step S108), the terminal control unit 11 stores the received information in the terminal storage unit 17 (step S109). In step S109, when the output destination printing machine candidate is not stored in the terminal storage unit 17, the terminal control unit 11 newly stores the received information in the terminal storage unit 17. When the output destination printing machine candidate is already stored in the terminal storage unit 17, the terminal control unit 11 updates the information in the terminal storage unit 17 in accordance with the received information. The information indicating the output destination printing machine candidate is, for example, the information illustrated in FIG. 5.

### Example of Processing of the Server According to the First Embodiment

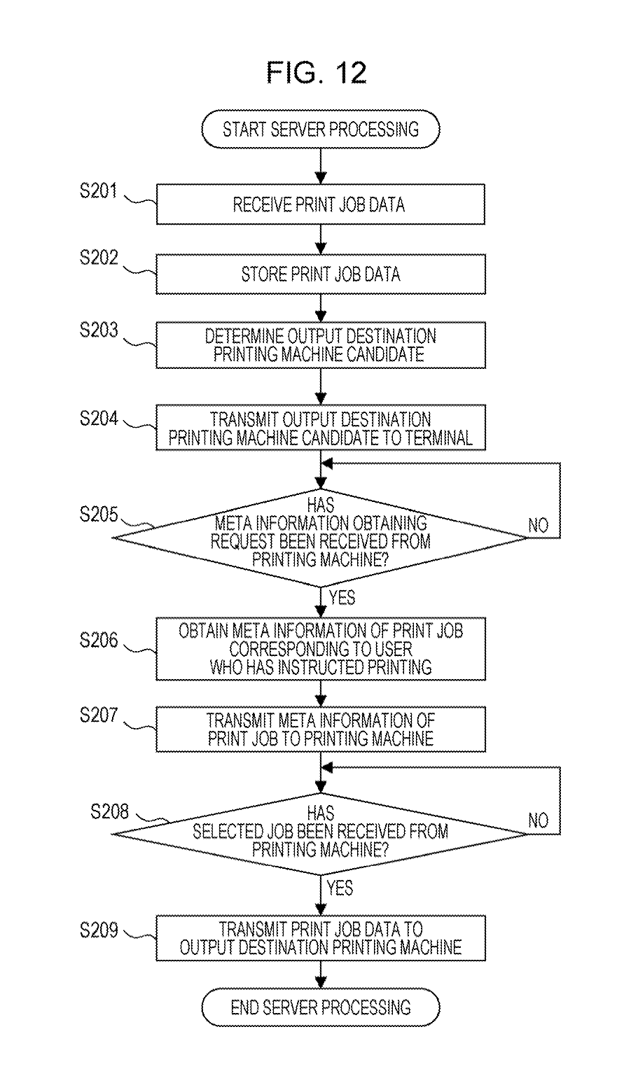

FIG. 12 is a flowchart illustrating an example of processing of the server according to the first embodiment. The server communication unit 21 receives print job data from the terminal 2 (step S201). The server control unit 22 stores the received print job data in the server storage unit 24 (step S202). In a case in which the server control unit 22 stores the print job data in the server storage unit 24, for example, even when transmission of intermediate format data from the server 3 to the printing machine 4 is not performed successfully, retransmission of the intermediate format data may be performed.

In addition, the determination unit 23 determines an output destination printing machine candidate (step S203). The determination unit 23 determines a printing machine 4 that is the previous output destination of the user or the terminal 2 indicated by the attribute information, to be an output destination printing machine candidate, for example, with reference to the print output logs illustrated in FIG. 7. For example, the determination unit 23 may determine a regular printing machine of the setting information illustrated in FIG. 6 to be an output destination printing machine candidate.

For example, the determination unit 23 may determine a printing machine 4 that is the recent output destination of the user or the terminal 2 indicated by the attribute information, to be an output destination printing machine candidate with reference to the print output logs during the specific time period illustrated in FIG. 7.

For example, the determination unit 23 may determine a printing machine 4 that is the previous output destination to be an output destination printing machine candidate, in accordance with the print output logs. In addition, a single or a plurality of output destination printing machine candidates may be applied. For example, when the two or more printing machines 4 each of which is the output destination are included in the print output logs during the specific time period, the determination unit 23 may determine the two or more printing machines 4 each of which the output destination to be an output destination printing machine candidate.

The server communication unit 21 transmits, to the terminal 2, information indicating the output destination printing machine candidate that has been determined by the determination unit 23 (step S204). When the print setting of the print job data that has been received from the terminal 2 includes information indicating a printing machine 4 that is an output destination, the output destination printing machine candidate may be the printing machine 4 that is the output destination, which is included in the print setting.

In addition, the server control unit 22 waits until the server control unit 22 receives a meta information obtaining request from the printing machine 4, and when the server control unit 22 does not receive a meta information obtaining request, the flow does not proceed to the next processing (NO in step S205). The meta information obtaining request received from the printing machine 4 includes, for example, user information that has been identified by the authentication unit 32 (for example, a user ID) and information used to identify the printing machine 4 (for example, a printing machine name).

When the server control unit 22 has received a meta information obtaining request from the printing machine 4 (YES in step S205), the server control unit 22 obtains, from the server storage unit 24, meta information on a print job corresponding to the user ID included in the received meta information obtaining request (step S206). In step S206, for example, the server control unit 22 obtains, from the server storage unit 24, the meta information on the print job corresponding to the received the user ID.

The meta information on the print job is included in the print job data. The meta information on the print job includes, for example, a user ID, a document name, a date and time (date and time at the time of a print instruction operation), a page, the number of sheets, and setting (print setting). The meta information on the print job is used, for example, for a display content of the job list screen displayed by the printing machine 4.

The server communication unit 21 transmits the meta information on the print job that has been obtained by the server control unit 22 to the printing machine 4 that is the output destination (printing machine 4 that has transmitted the meta information obtaining request) (step S207). In addition, the job list screen based on the transmitted meta information is displayed on the touch panel display 33 of the printing machine 4.

When the user selects a certain job from the job list screen, the printing machine 4 accepts the selection. The printing machine 4 transmits information used to identify the selected job (for example, a job ID) to the server 3.

The server control unit 22 waits until the server control unit 22 receives the information used to identify the selected job from the printing machine 4 that is the output destination, and when the server control unit 22 does not receive the information, the flow does not proceed to the next processing (NO in step S208).

When “YES” is determined in step S208, the server communication unit 21 transmits print job data that has been selected from among pieces of print job data stored in the server storage unit 24 to the printing machine 4 that is the output destination (step S209). In step S209, the server communication unit 21 transmits, for example, intermediate format data included in the print job data to the printing machine 4 that is the output destination.

In addition, when the server 3 includes a printer driver, the printer driver may convert the intermediate format data into print format data. In addition, in step S209, the server communication unit 21 may transmit the print format data to the printing machine 4 that is the output destination. In a case in which the server 3 transmits the print format data to the printing machine 4 that is the output destination, even when the printing machine 4 does not include a conversion function into print format data, the printing may be executed.

### Example of Processing of the Printing Machine According to the First Embodiment

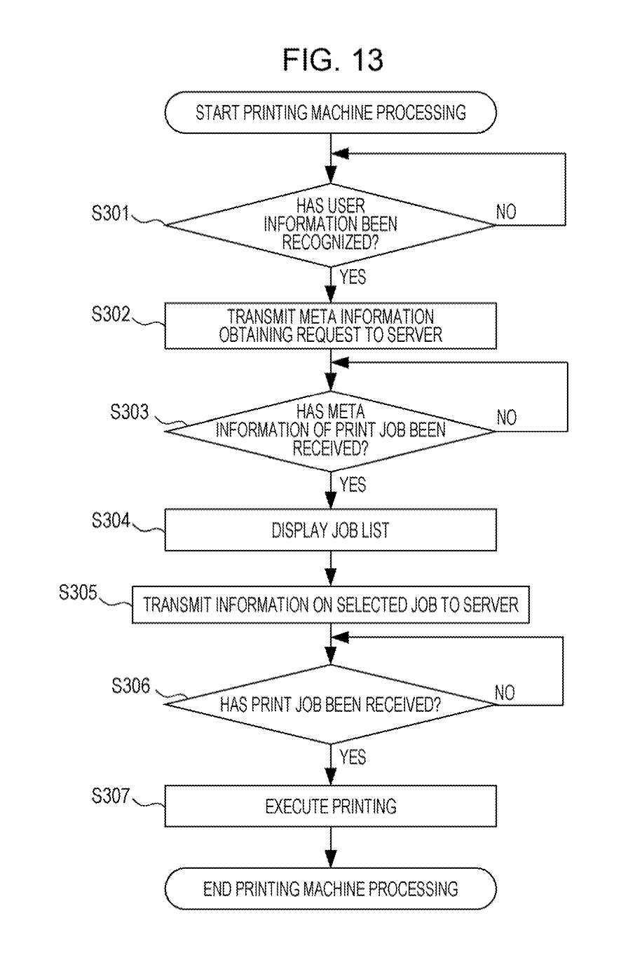

FIG. 13 is a flowchart illustrating an example of processing of the printing machine according to the first embodiment. The printing machine control unit 31 determines whether user information has been recognized (step S301). For example, when the touch panel display 33 has accepted an input of the user information or the authentication unit 32 has performed authentication (user authentication), the printing machine control unit 31 determines that the user information has been recognized.

When “YES” is determined in step S301, the printing machine communication unit 34 transmits, to the server 3, a meta information obtaining request including the recognized user information (for example, the user ID) and the information used to identify the printing machine 4 (for example, the printing machine name) (step S302).

The printing machine control unit 31 determines whether meta information on a print job has been received from the server 3 (step S303). When the meta information on the print job has not been received from the server 3, in the printing machine control unit 3, the flow does not proceed to the next processing (NO in step S303).

When the meta information on the print job has been received from the server 3 (YES in step S303), the touch panel display 33 display a job list screen in accordance with the meta information on the print job, which has been transmitted from the server 3 (step S304). The job list screen is, for example, the screen illustrated in FIG. 10. When the user touches one of items of the job list screen, a corresponding job is selected.

The printing machine communication unit 34 transmits, to the server 3, information used to identify the job that has been selected from the job list screen illustrated in FIG. 5 (for example, the job ID) (step S305).

The printing machine control unit 31 determines whether print job data has been received from the server 3 (step S306). The printing machine control unit 31 waits until the printing machine control unit 31 receives print job data, and the flow does not proceed to the next processing (NO in step S306)

The print job data transmitted from the server 3 includes, for example, intermediate format data or print format data. When the printing machine 4 has received intermediate format data, the printing machine conversion unit 35 converts the intermediate format data into print format data before execution of the printing.

In addition, the printing machine control unit 31 executes print processing in accordance with the print format data (step S307).

### Example of Processing of the Terminal when the Server According to the First Embodiment is not Available

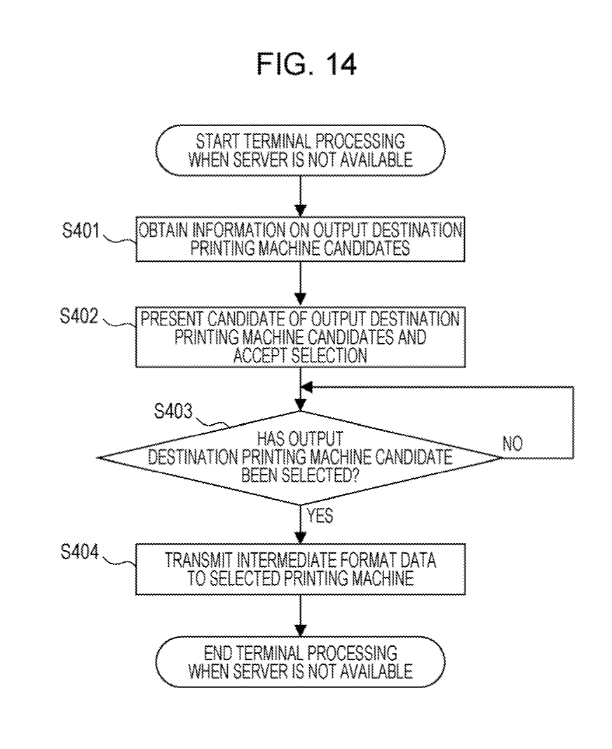

FIG. 14 is a diagram illustrating an example of processing of the terminal when the server according to the first embodiment is not available. The processing illustrated in FIG. 14 is an example of the processing of S107 in FIG. 11.

The terminal control unit 11 obtains information indicating output destination printing machine candidates from the terminal storage unit 17 (step S401). The information that has been obtained in step S401 is the information indicating the output destination printing machine candidates, which has been stored into the terminal storage unit 17 or has been updated in step S109 when the server 3 has been available.

The terminal control unit 11 controls the terminal display unit 16 to display the output destination printing machine candidates, and accepts an operation to select one of the output destination printing machines (step S402). The screen displayed on the terminal display unit 16 is, for example, the screen illustrated in FIG. 9.

In the terminal control unit 11, the flow does not proceed to the next processing (NO in step S403) until one of the presented output destination printing machine candidates is selected. For example, when the terminal display unit 16 is a touch panel display, and the user has touched one of the display output destination printing machine candidates, the terminal control unit 11 recognizes the selected output destination printing machine candidate. In addition, the terminal control unit 11 may recognize the selected output destination printing machine candidate in accordance with a selection operation using the terminal input unit 15 by the user.

A printing machine 4 that is one of the presented output destination printing machine candidates has been selected (YES in step S403), the terminal communication unit 18 transmits intermediate format data to the selected printing machine 4 (step S404). The intermediate format data transmitted in step S404 is the intermediate format data that has been generated in step S103 of FIG. 11.

In the processing when the above-described server is not available, the server 3 is not used, such that the server 3 does not store print output logs. Thus, the terminal storage unit 17 may store print output logs during a time period when the server 3 is not available and transmit the print output logs to the server 3 when the next printing using the server 3 is executed.

In addition, for example, when the operation status of the server 3 is monitored at specific time interval, the terminal 2 may transmit, to the server 3, the print output logs during the time period in which the server 3 is not available when it has been detected that the server 3 is available. For example, the terminal 2 is a thin client terminal by which virtualization of a desktop (virtual desktop interface (VDI)) is realized, and the log-on status is maintained, the terminal 2 may transmit the print output logs at the time when the server 3 has been restored such as during the night when the user is not working or the like.

When the terminal 2 transmits, to the server 3, the print output logs related to the printing during the time period when the server 3 is not available, the server 3 may centralize print output logs including the print output logs during the time period when the server 3 is not available.

As described above, in the embodiment, when the server 3 is available, output destination printing machine candidates are stored, and when the server 3 is not available, the stored output destination printing machine candidates are presented. Thus, the convenience of printing in a status in which the server 3 used for execution of the printing is not available may be increased.

### Modification of the Processing of the Server According to the First Embodiment

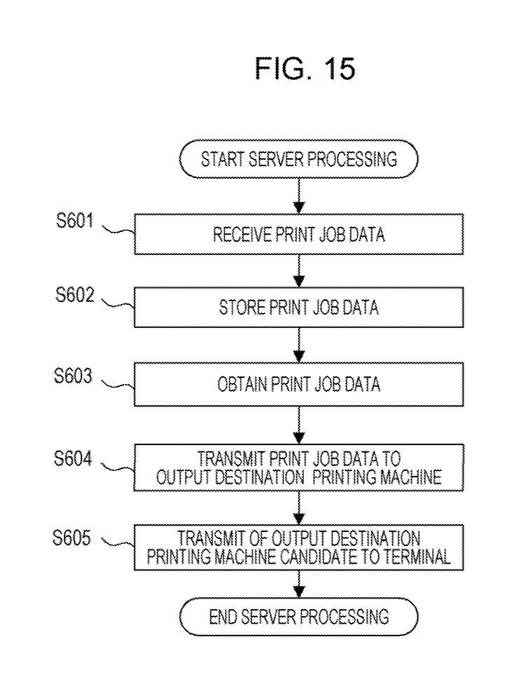

FIG. 15 is a flowchart illustrating a modification of the processing of the server according to the first embodiment. Processing of the server 3 in the modification of the first embodiment is assumed for a case in which specification of a printing machine 4 that is an output destination is included in the print setting in step S101 of the processing of the terminal 2 illustrated in FIG. 11.

The server communication unit 21 receives print job data from the terminal 2 (step S601). The server control unit 22 stores the received print job data in the server storage unit 24 (step S602). In a case in which the server control unit 22 stores the print job data in the server storage unit 24, for example, even when transmission of intermediate format data from the server 3 to the printing machine 4 is not performed successfully, retransmission of the intermediate format data may be performed.

In addition, the server control unit 22 obtains print job data stored in the server storage unit 24 (step S603). The server communication unit 21 transmits the obtained print job data to the printing machine 4 that is the output destination specified in print setting of the print job data (step S604). In step S604, for example, the server communication unit 21 transmits intermediate format data included in the print job data to the printing machine 4 that is the output destination.

In addition, when the server 3 includes a printer driver, the printer driver may convert the intermediate format data into print format data. In addition, in step S604, the server communication unit 21 may transmit the print format data to the printing machine 4 that is the output destination.

The server communication unit 21 transmits, to the terminal 2, Information indicating an output destination printing machine candidate (step S605). Information on the printing machine 4 that the server communication unit 21 transmits to the terminal 2 in step S605 may correspond to the printing machine 4 to which the print job data has been transmitted in step S604 or a regular printing machine indicated by the setting information (for example, see FIG. 6).

### Modification of the Processing of the Printing Machine According to the First Embodiment

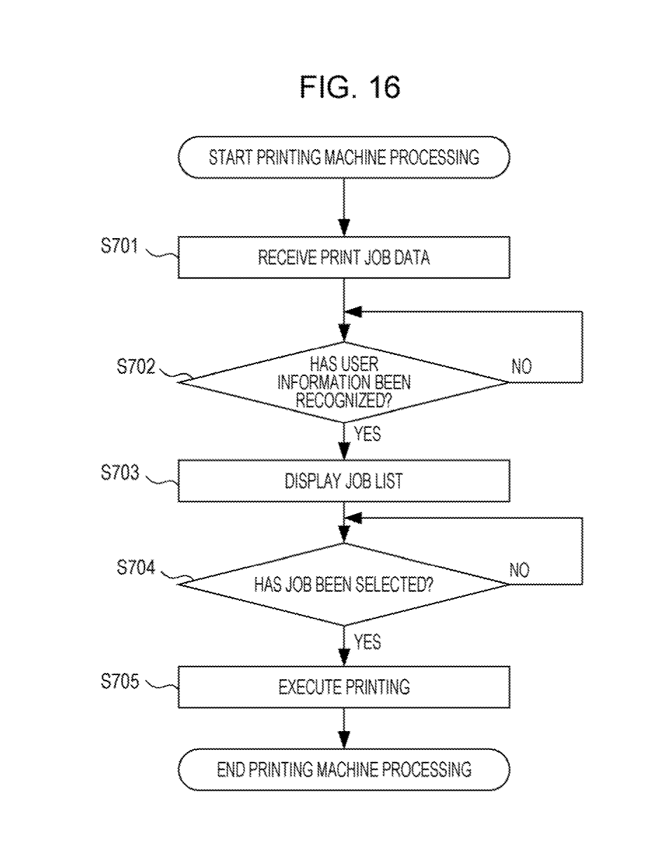

FIG. 16 is a flowchart illustrating a modification of the processing of the printing machine according to the first embodiment. The processing of the printing machine 4 illustrated in FIG. 16 corresponds to the processing of the server illustrated in FIG. 15.

The printing machine communication unit 34 receives the print job data from the server 3 (step S701). In the modification of the processing of the printing machine according to the first embodiment, the printing machine 4 that is the output destination is specified in the print setting of the print job data, and the print job data is transmitted from the server 3 even without transmission of an output instruction from the printing machine 4.

The printing machine control unit 31 determines whether user information has been recognized (step S702). For example, when the touch panel display 33 has accepted an input of the user information or the authentication unit 32 has performed authentication (user authentication), the printing machine control unit 31 determines that the user information has been recognized.

When “YES” is determined in step S702, the touch panel display 33 displays a job list screen in accordance with meta information included in the print job data that has been transmitted from the server 3 (step S703). The job list screen is, for example, the screen illustrated in FIG. 10. When the user touches one of items on the job list screen, a corresponding job is selected.

In addition, the printing machine control unit 31 executes print processing of the selected print job in accordance with the print job data that has been received in step S701 (step S705). The print job data transmitted from the server 3 includes, for example, intermediate format data or print format data. When the printing machine 4 has received intermediate format data, the printing machine conversion unit 35 converts the intermediate format data into print format data before execution of the printing. In addition, the printing machine control unit 31 executes the printing by using the converted print format data in step S705.

As described above, in the modification illustrated in FIGS. 15 and 16, the terminal 2 specifies the printing machine 4 that is the output destination, such that the server communication unit 21 transmits the print job data to the specified printing machine 4 without waiting for an output instruction from the printing machine 4. Thus, a waiting time until the printing machine 4 receives the print job data after the user has been authenticated in the printing machine 4 may be reduced.

### Example of a Terminal According to a Second Embodiment

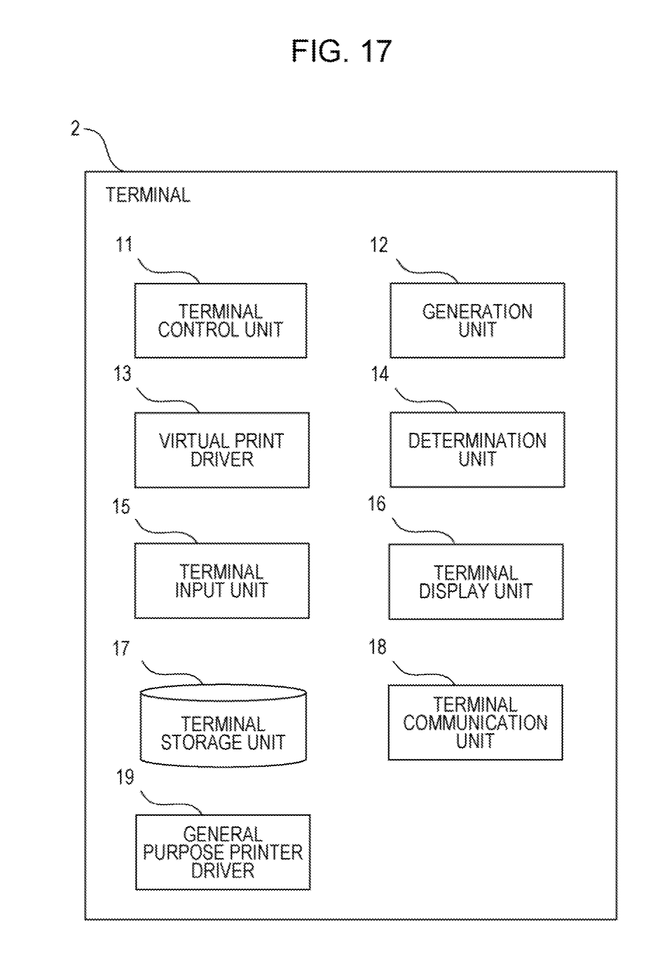

FIG. 17 is a diagram illustrating an example of a terminal according to a second embodiment. A configuration of a terminal 2 according to the second embodiment is different from that of the terminal 2 according to the first embodiment illustrated in FIG. 2 in that the terminal 2 according to the second embodiment includes a general purpose printer driver 19.

The general purpose printer driver 19 is a printer driver corresponding to two or more types of the printing machines 4. That is, the general purpose printer driver 19 generates print format data corresponding to the two or more types of the printing machines 4 by converting intermediate format data.

In addition, the terminal communication unit 18 transmits the generated print format data to the printing machine 4. The terminal 2 may include two or more types of general purpose printer drivers 19 respectively corresponding to different types of the printing machines 4. When the general purpose printer driver 19 does not correspond to all types of the printing machines 4, the terminal 2 may deal with various types of the printing machines 4 so as to include two or more types of general purpose printer drivers 19.

### Example of Processing of the Terminal when the Server According to the Second Embodiment is not Available

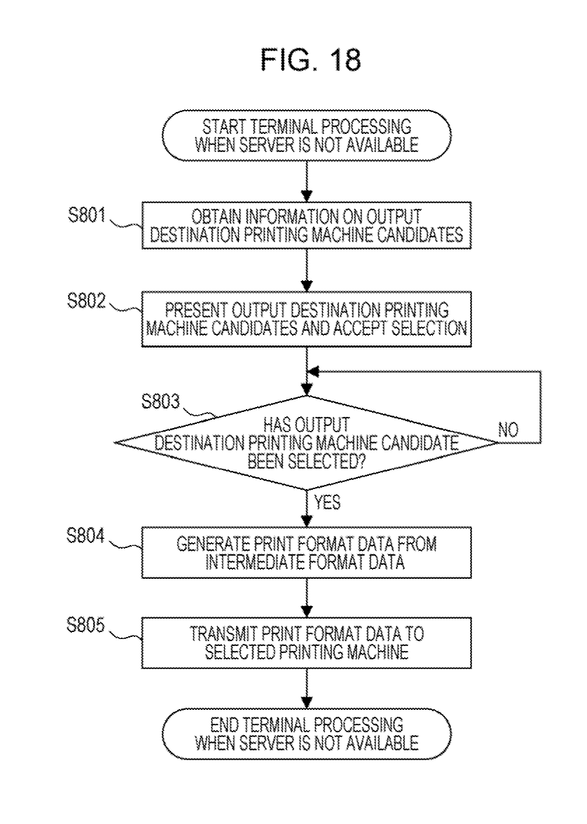

FIG. 18 is an example of processing of the terminal when the server according to the second embodiment is not available. The processing of the terminal 2 according to the second embodiment is similar to the processing illustrated in FIG. 11. The processing illustrated in FIG. 18 is an example of the processing in step S107 of FIG. 11. In addition, the processing of the server 3 is similar to the processing in the first embodiment illustrated in FIG. 12 or 15. In addition, the processing of the printing machine 4 may be similar to the processing in the first embodiment illustrated in FIG. 13 or 16.

In addition, in FIG. 18, processing of steps S801 to S803 is similar to the processing of steps S401 to S403 illustrated in FIG. 14, and therefore, a description is omitted herein.

When a printing machine 4 is selected from among the presented output destination printing machine candidates (YES in step S803), the general purpose printer driver 19 generates print format data corresponding to the selected printing machine 4 by converting intermediate format data (step S804). In addition, the printing machine communication unit 34 transmits the print format data to the selected printing machine 4 (step S805).

The terminal 2 according to the embodiment converts, through the general purpose printer driver 19, the intermediate format data into print format data allowed to be printed by two or more types of the printing machines 4, such that the printing may be executed even when print formats by printer drivers respectively corresponding to the printing machines 4 are not provided.

### Example of a Terminal According to a Third Embodiment

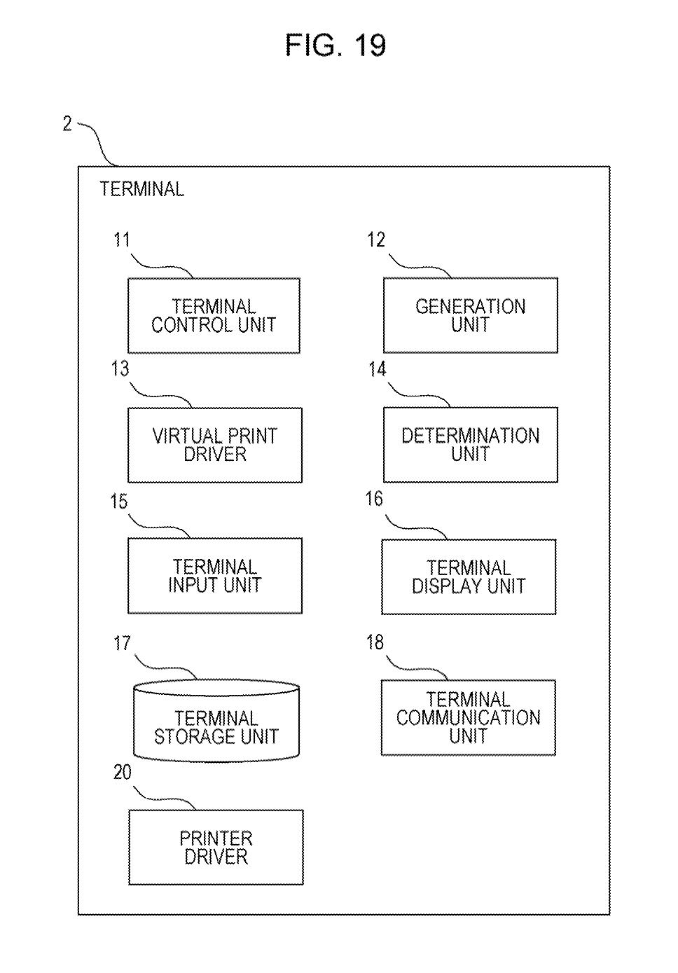

FIG. 19 is an example of a terminal according to a third embodiment. A configuration of a terminal 2 according to the third embodiment is different from that of the terminal 2 according to the first embodiment illustrated in FIG. 2 in that the terminal 2 according to the third embodiment includes a printer driver 20.

The printer driver 20 is a printer driver corresponding to an output destination printing machine candidate. That is, the printer driver 20 converts intermediate format data into print format data allowed to be printed by the output destination printing machine candidate. The printer driver 20 corresponds to the output destination printing machine candidate, such that the printer driver 20 may convert the intermediate format data into print format data corresponding to the printing machine 4, for example, even when specific print setting is included in the intermediate format data.

The printer driver 20 is transmitted from the server 3 to the terminal 2 with information indicating the output destination printing machine candidate and is stored in the terminal storage unit 17. In addition, the terminal control unit 11 installs the printer driver 20 in the terminal 2 before execution of the printing.

When print format data corresponding to a printing machine 4 is different for each model or for two or more models of a specific vender, it is assumed that the printer driver 20 is a printer driver corresponding to a specific model or a group of two or more models of a specific vender. When print format data corresponding to a printing machine 4 is different for each vender, it is assumed that the printer driver 20 is a printer driver corresponding to a printer of a specific vender.

### Example of Processing of the Terminal According to the Third Embodiment

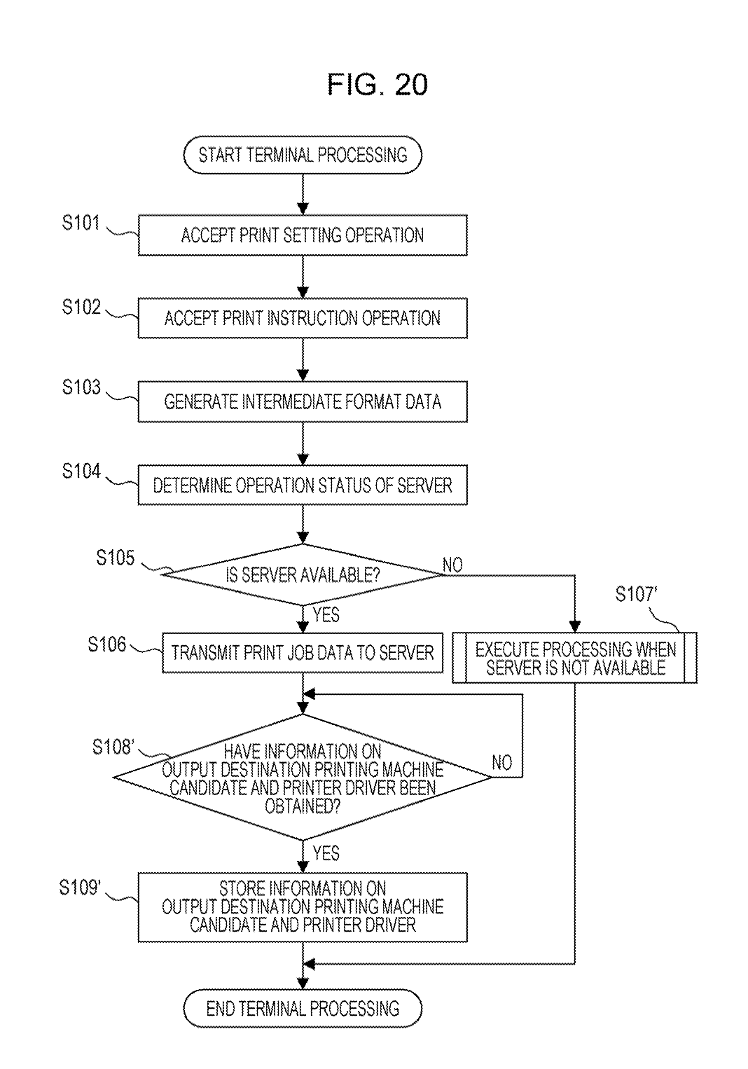

FIG. 20 is a flowchart illustrating processing of the terminal according to the third embodiment. In FIG. 20, processing of steps S101 to S106 is similar to the processing illustrated in FIG. 11, and therefore, a description of a part of the processing is omitted herein. Processing of step S107′ is described later in detail.

In the embodiment, when a server is available (YES in step S105), information indicating an output destination printing machine candidate and a printer driver 20 corresponding to the output destination printing machine candidate are transmitted from the server 3.

After the processing of step S106, the terminal control unit 11 waits until the terminal control unit 11 receives (obtains) the information indicating the output destination printing machine candidate and the printer driver 20 corresponding to the printing machine 4, and the flow does not proceed to the next processing before the reception (No in step S108′).

When “YES” Is determined in step S108′, the received information indicating the output destination printing machine candidate and printer driver 20 corresponding to the printing machine 4 are stored in the terminal storage unit 17 (step S109′). The information indicating the output destination printing machine candidate is, for example, the information illustrated in FIG. 8.

In step S109′, when the output destination printing machine candidate and the printer driver 20 corresponding to the output destination printing machine candidate are not stored in the terminal storage unit 17, the terminal control unit 11 newly stores the received information.

When the output destination printing machine candidate and the printer driver 20 corresponding to the output destination printing machine candidate are already stored in the terminal storage unit 17, the terminal control unit 11 updates the information in the terminal storage unit 17 in accordance with the received information.

### Example of Processing of the Server According to the Third Embodiment

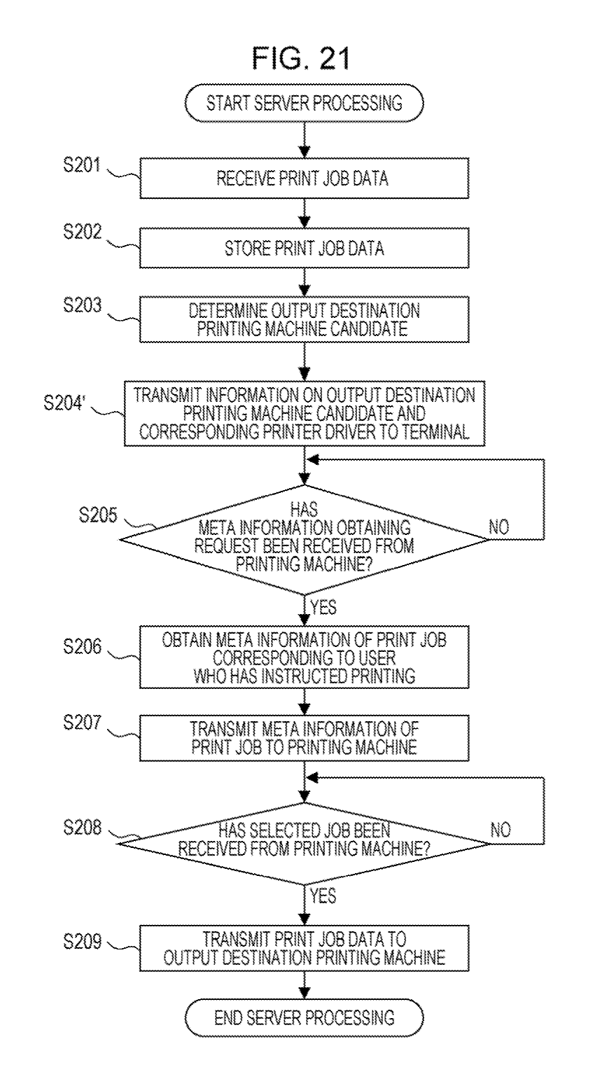

FIG. 21 is a flowchart illustrating processing of the server according to the third embodiment. In FIG. 20, processing of steps S201 to S203 and S205 to S209 is similar to the processing illustrated in FIG. 12, and therefore, a description is omitted herein.

The server communication unit 21 transmits, to the terminal 2, information indicating an output destination printing machine candidate that has been determined by the determination unit 23 and a printer driver 20 corresponding to the output destination printing machine candidate (step S204′). The server communication unit 21 may transmit, to the terminal 2, a module related to the printer driver 20, with the printer driver 20.

### Example of Processing of the Terminal when the Server According to the Third Embodiment is not Available

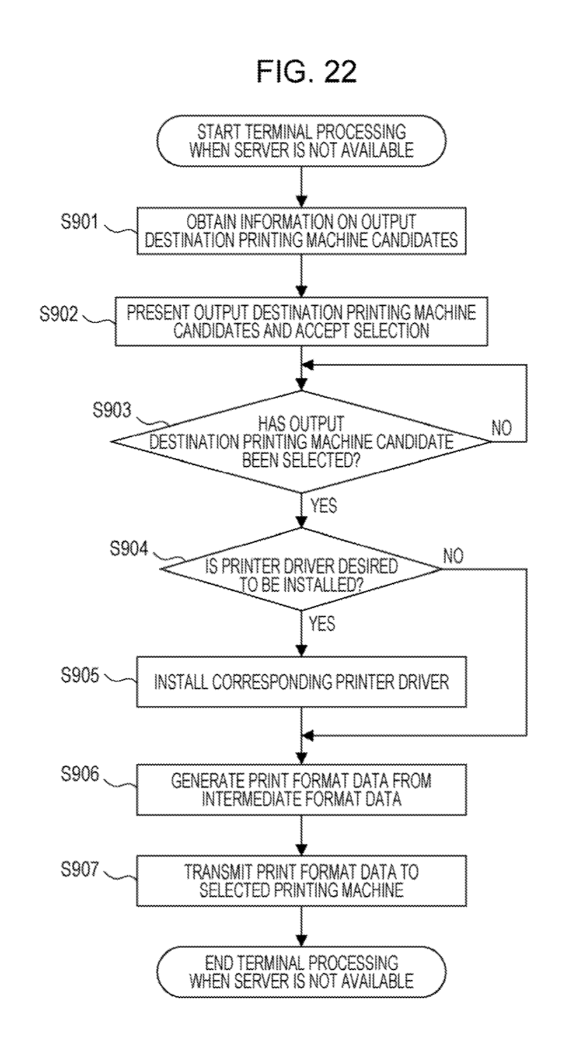

FIG. 22 is a diagram illustrating an example of processing of the terminal when the server according to the third embodiment is not available. The processing illustrated in FIG. 22 is an example of the processing of step S107′ in FIG. 20.

The terminal control unit 11 obtains information indicating output destination printing machine candidates from the terminal storage unit 17 (step S901). The information obtained in step S901 is the information indicating the output destination printing machine candidates, which has been stored or updated in step S109′ of FIG. 20 when the server 3 has been available in the past.

The terminal control unit 11 accepts an operation to select one of the output destination printing machines by causing the terminal display unit 16 to display the output destination printing machine candidates (step S902). The screen displayed on the terminal display unit 16 is, for example, the screen illustrated in FIG. 9.

In the terminal control unit 11, the flow does not proceed to the next processing until one of the presented output destination printing machine candidates is selected (NO in step S903).

When a printing machine 4 is selected from among the presented output destination printing machine candidates (YES in step S903), the terminal control unit 11 determines whether a printer driver 20 of the selected printing machine 4 is desired to be installed into the terminal 2 (step S904). For example, when the printer driver of the selected printing machine 4 is yet to be installed, the terminal control unit 11 determines that the installation is desired, and when the printer driver of the selected printing machine 4 has been already installed into the terminal 2, the terminal control unit 11 determines that the installation is not desired.

When “YES” is determined in step S904, the terminal control unit 11 obtains a printer driver 20 corresponding to the selected printing machine 4 from the terminal storage unit 17 and installs the print driver 20 into the terminal 2 (step S905). When the installed printer driver 20 is a printer driver 20 that has been stored or updated in step S109′ of FIG. 20 when the server 3 has been available in the past.

The installed printer driver 20 generates print format data corresponding to the selected printing machine 4 by converting the intermediate format data that has been generated in step S103 of FIG. 20 (step S906).

The terminal communication unit 18 transmits the generated print format data to the selected printing machine 4 (step S907).

As described above, in the embodiment, the terminal 2 installs the printer driver 20 corresponding to the selected printing machine 4. Thus, even when the printing machine 4 does not include a printer driver, the printing may be executed. In addition, even when specific print setting or the like is included in the intermediate format data, the terminal 2 may generate print format data corresponding to the printing machine 4.

### Example of a Hardware Configuration of the Terminal

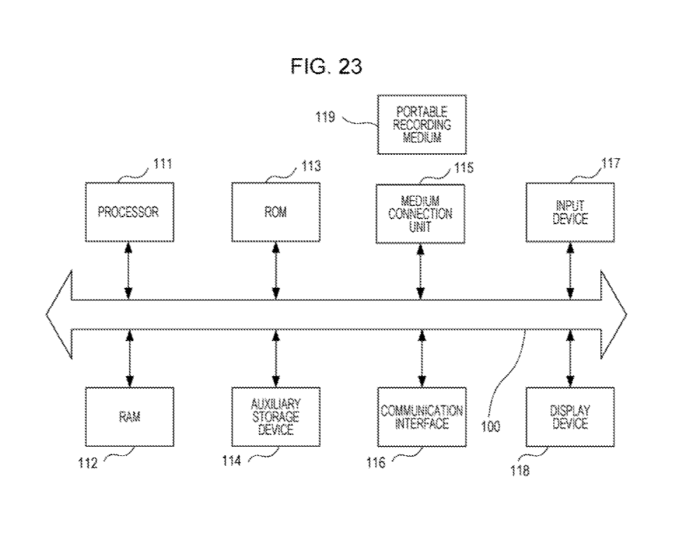

An example of a hardware configuration of the terminal 2 is described below with reference to FIG. 23. As illustrated in FIG. 23, a processor 111, a random access memory (RAM) 112, and a read only memory (ROM) 113 are coupled to each other through a bus 100. The processor 111 is, for example, a CPU.

In addition, an auxiliary storage device 114, a medium connection unit 115, a communication interface 116, an input device 117, and a display device 118 are coupled to each other through the bus 100. The processor 111 executes a program that has been deployed to the RAM 112. As the executed program, a program used to execute the processing in the embodiment may be applied.

The ROM 113 is a non-volatile storage device that stores the program to be deployed to the RAM 112. The auxiliary storage device 114 is a storage device that stores various pieces of information, and for example, a semiconductor memory or the like may be applied to the auxiliary storage device 114.

The medium connection unit 115 is provided so as to be coupled to a portable recording medium 119. When the terminal 2 is a thin client terminal, the auxiliary storage device 114 and the medium connection unit 115 may not be included in the terminal 2.

A portable memory may be applied to the portable recording medium 119. The program used to execute the processing in the embodiment may be recorded in the portable recording medium 119.

The terminal storage unit 17 may be realized by the RAM 112, the auxiliary storage device 114, or the like. The terminal communication unit 18 may be realized by the communication interface 116. The terminal input unit 15 may be realized by the input device 117. The terminal display unit 16 may be realized by the display device 118.

Each of the terminal control unit 11, the generation unit 12, the virtual print driver 13, and the determination unit 14 may be realized when a specific program is executed by the processor 111.

The RAM 112, the ROM 113, the auxiliary storage device 114, and the portable recording medium 119 are examples of computer-readable tangible storage mediums. These tangible storage mediums are not transitory mediums such as signal carrier waves.

### Example of a Hardware Configuration of the Server

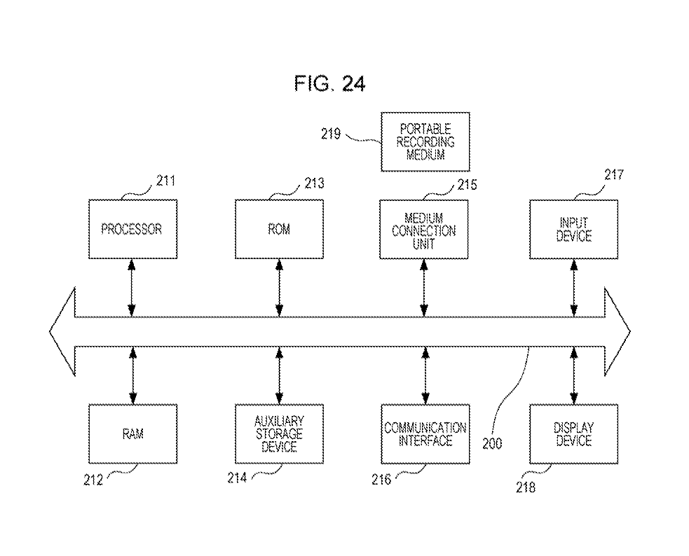

An example of a hardware configuration of the server 3 is described below with reference to FIG. 24. As illustrated in FIG. 24, a processor 211, an RAM 212, and an ROM 213 are coupled to each other through a bus 200. The processor 211 is, for example, a CPU.

In addition, an auxiliary storage device 214, a medium connection unit 215, a communication interface 216, an input device 217, and a display device 218 are coupled to each other through the bus 200. The processor 211 executes a program that has been deployed to the RAM 212. As the executed program, a program used to execute the processing in the embodiment may be applied.

The ROM 213 is a non-volatile storage device that stores the program to be deployed to the RAM 212. The auxiliary storage device 214 is a storage device that stores various pieces of information, and for example, a hard disk, a semiconductor memory, or the like, may be applied to the auxiliary storage device 214. The medium connection unit 215 is provided so as to be coupled to a portable recording medium 219.

A portable memory, an optical disk (for example, a compact disc (CD) or a digital versatile disc (DVD)), or the like, may be applied to the portable recording medium 219. The program used to execute the processing in the embodiment may be recorded in the portable recording medium 219.

The server storage unit 24 may be realized by the RAM 212, the auxiliary storage device 214, or the like. The server communication unit 21 may be realized by the communication interface 216. Each of the server control unit 22 and the determination unit 23 may be realized when a specific program is executed by the processor 211.

The RAM 212, the ROM 213, the auxiliary storage device 214, and the portable recording medium 219 are examples of computer-readable tangible storage mediums. These tangible storage mediums are not transitory mediums such as signal carrier waves.

### Example of a Hardware Configuration of the Printing Machine

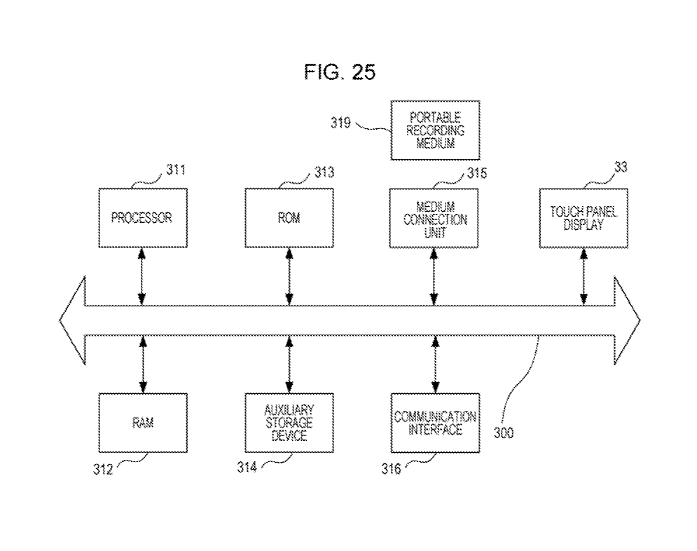

An example of a hardware configuration of the printing machine 4 is described below with reference to FIG. 25. As illustrated in FIG. 25, a processor 311, a RAM 312, and a ROM 313 are coupled to each other through a bus 300. The processor 311 is, for example, a CPU.

In addition, an auxiliary storage device 314, a medium connection unit 315, a communication interface 316, and a touch panel display 33 are coupled to each other through the bus 300. The processor 311 executes a program that has been deployed to the RAM 312. As the executed program, a program used to execute the processing in the embodiment may be applied.

The ROM 313 is a non-volatile storage device that stores the program to be deployed into the RAM 312. The auxiliary storage device 314 is a storage device that stores various pieces of information, and for example, a hard disk, a semiconductor memory, or the like, may be applied to the auxiliary storage device 314. The medium connection unit 315 is provided so as to be coupled to a portable recording medium 319.

A portable memory, an optical disk (for example, a CD or a DVD), or the like, may be applied to the portable recording medium 319. The program used to execute the processing in the embodiment may be recorded in the portable recording medium 319.

The printing machine storage unit 36 may be realized by the RAM 312, the auxiliary storage device 314, or the like. The printing machine communication unit 34 may be realized by the communication interface 316. Each of the printing machine control unit 31, the authentication unit 32, and the printing machine conversion unit 35 may be realized when a specific program is executed by the processor 311.

The RAM 312, the ROM 313, the auxiliary storage device 314, and the portable recording medium 319 are examples of computer-readable tangible storage mediums. These tangible storage mediums are not transitory mediums such as signal carrier waves.

### Other Examples

For example, when the terminal 2 is a thin client terminal, it is difficult to install printer drivers corresponding to the two or more printing machines 4 into the terminal 2. In the embodiment, it is only sufficient that a printer driver (virtual print driver 13) used to print intermediate format data is installed into the terminal 2, and two or more printer drivers may not be installed into the terminal 2.

The server 3 may instruct a certain printing machine 4 to execute normal printing by setting the printing machine 4 as a print output destination even when two or more printer drivers are not installed in the terminal 2. In addition, for example, even when the terminal 2 is not a thin client terminal, similarly, an installation work of a printer driver may be omitted.

As described in the second embodiment, a general purpose printer driver 19 corresponding to an output destination printing machine candidate may be installed into the terminal 2 as appropriate. In addition, as illustrated in the third embodiment, a printer driver 20 corresponding to an output destination printing machine candidate may be installed into the terminal 2 as appropriate.

The technology discussed herein is not limited to the above-described embodiments, and various configurations or embodiments may be applied to the technology discussed herein without departing from the gist of the technology discussed herein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer readable medium storing a program that causes a computer to execute a process, the computer transmitting a print instruction data to a server device, the process comprising:
obtaining information regarding a printer device from the server device, the server device transmitting print output data to execute a printing to the printer device, the printer device to which the print output data is transmitted being determined based on an output request from the printer device or output destination information included in the print instruction data received from the computer;
determining whether the server is available upon a reception of a print operation;
presenting candidates of the printer device to which the print output data corresponding to the print operation is transmitted based on the information when the server is determined to be not available; and
transmitting the print output data corresponding to the print operation to a specific printer device selected from the candidates.

2. The non-transitory computer readable medium according to claim 1, wherein
the determining determines an operation status of the server when the print operation is received.

3. The non-transitory computer readable medium according to claim 1, wherein
the print instruction data includes intermediate format data corresponding to a plural kinds of printer devices; and wherein
the process further comprises:
generating the intermediate format data upon the reception of the print operation;
accepting an operation to select the specific printer device from among the candidates; and
transmitting the print output data corresponding to the print operation to the specific printer device selected in the operation to select.

4. The non-transitory computer readable medium according to claim 1, wherein
the print instruction data includes intermediate format data corresponding to a plural kinds of printer devices; and wherein
the process further comprises:
generating the intermediate format data upon the reception of the print operation;
accepting an operation to select the specific printer device from among the candidates;
generating print format data corresponding to the specific printer device based on the intermediate format data by using a printer driver corresponding to the plural kinds of printer devices; and
transmitting the print format data to the specific printer device.

5. The non-transitory computer readable medium according to claim 1, wherein
the print instruction data includes intermediate format data corresponding to a plural kinds of printer devices; and wherein
the process further comprises:
generating the intermediate format data upon the reception of the print operation;
accepting an operation to select the specific printer device from among the candidates;
obtaining a printer driver corresponding to the specific printer device from the server device;
generating print format data corresponding to the specific printer device based on the intermediate format data by using a printer driver corresponding to the specific printer device; and
transmitting the print format data to the specific printer device.

6. The non-transitory computer readable medium according to claim 1, wherein the process further comprises:
transmitting a detection signal to the server device upon the reception of the print operation;
determining an operation status of the server device based on whether a response corresponding to the detection signal is received; and
determining whether the server device is available based on the operation status.

7. The non-transitory computer readable medium according to claim 1, wherein the process further comprises:
detecting a status of the server device at specific time interval;
determining an operation status of the server device based on a detection result upon the reception of the print operation; and
determining whether the serve is available in accordance with the operation status.

8. The non-transitory computer readable medium according to claim 1, wherein the process further comprises:
storing, in the storage device, print output logs during a time period in which the server device is not available; and
transmitting the print output logs stored in the storage device to the server device when the server device becomes available.

9. A print control device comprising:
a memory; and
a processor coupled to the memory and the processor configured to execute a process, the process including:
transmitting a print instruction data to a server device;
obtaining information regarding a printer device from the server device, the server device transmitting print output data to execute a printing to the printer device, the printer device to which the print output data is transmitted being determined based on an output request from the printer device or output destination information included in the print instruction data received from computer;
determining whether the server is available upon a reception of a print operation;
presenting candidates of the printer device to which the print output data corresponding to the print operation is transmitted based on the information when the server is determined to be not available; and
transmitting the print output data corresponding to the print operation to a specific printer device selected from the candidates.

10. A print control system comprising:
a server device including:
a first memory; and
a first processor coupled to the first memory and the first processor configured to execute a first process, the first process including:
transmitting print output data to execute a printing to a printer device, the printer device to which the print output data is sent being determined based on an output request from the printer device or output destination information included in print instruction data received from a computer; and
the computer including:
a second memory; and
a second processor coupled to the second memory and the second processor configured to execute a second process, the second process including:
transmitting the print instruction data to the server device;
obtaining information regarding the printer device from the server device;
determining whether the server is available upon a reception of a print operation;
presenting candidates of the printer device to which the print output data corresponding to the print operation is transmitted based on the information when the server is determined to be not available; and
transmitting the print output data corresponding to the print operation to a specific printer device selected from the candidates.
